(19) United States
(12) Patent Application Publication
(10) Pub. No.: US 2003/0192051 A1
(43) Pub. Date: Oct. 9, 2003

(54) Interactive television system

(75) Inventor: Henry C. Yuen, Pasadena, CA (US)

Correspondence Address: CHRISTIE, PARKER & HALE, LLP, P.O. BOX 7068, PASADENA, CA, 91109-7068, US

(73) Assignee: Index Systems, Inc.

(21) Appl. No.: 10/386,647

(22) Filed: Mar. 12, 2003

Related U.S. Application Data
(63) Continuation of application No. 09/158,436, filed on Sep. 21, 1998.
Application No. 09/158,436 is a continuation-in-part of application No. 08/879,146, filed on Jun. 19, 1997, now Pat. No. 5,812,931.
(60) Provisional application No. 60/028,555, filed on Oct. 15, 1996.

(30) Foreign Application Priority Data
Feb. 21, 1997 (WO) PCT/US97/02642

(51) Int. Cl. H04N 7/16; H04N 7/173

(52) U.S. Cl. 725/62; 725/123; 725/110

(57) ABSTRACT

A system for two-way communication between a television viewer operating a remote control unit to control a television and a television signal or other information provider located at a central site. A set-top box coupled to the television includes an infrared receiver to receive command signals from the remote control unit, a pager transmitter to transmit messages to the television signal or other information provider, and a pager receiver to receive confirmation messages from the television signal or other information provider. Also included is a controller to control reception of command signals from the remote control unit, reception of a television signal, display of the television signal on the television, translation of the command signals into messages to be sent by the pager transmitter, reception of confirmation messages from the pager receiver, and display of received confirmation messages on the television. Alternatively, the infrared receiver, pager transmitter, pager receiver, and controller are integral with the television.

### CROSS REFERENCE TO RELATED APPLICATIONS

This application is a continuation of U.S. patent application Ser. No. 09/158,436, filed on Sep. 21, 1998, which is a continuation-in-part of U.S. patent application Ser. No. 08/879,146, filed Jun. 19, 1997 issued on Sep. 22, 1998 as U.S. Pat. No. 5,812,931, which claims the benefit of PCT Application No. PCT/US97/02642, filed Feb. 21, 1997, U.S. Provisional Application No. 60/028,555, filed Oct. 15, 1996, and U.S. Provisional Application No. 60/012,146, filed Feb. 23, 1996.

### FIELD OF THE INVENTION

This invention relates generally to interactive television systems and more specifically to an interactive television system integrated with pager communications technology to allow two-way communication between the interactive television system and a central site.

### BACKGROUND OF THE INVENTION

In the consumer television industry, there are many instances where two-way communications between a television signal provider at a central site and the television viewer is desired. In the case of over-the-air broadcast television, cable television, C-band satellite and direct satellite broadcasting, the link from the television signal provider to the television viewer is well established and has a wide bandwidth, and is capable of carrying a large amount of information (including both the television signals and other analog and digital information). A problem that consistently arises is how to establish a second communication link back from the television viewer to the television signal provider.

The most common solution to this problem is to use a telephone link. Many cable systems and direct broadcast satellite systems use this solution. One of the problems with using the telephone to provide the link from the television viewer to the television signal provider is that the television receiver (e.g., cable box, direct satellite receiver, or other set-top box) must either be positioned near a telephone jack or a telephone cable of considerable length must be strung from the receiver to the telephone jack. Another problem is that the telephone link cannot be used at the same time that the television viewer is using the telephone for normal telephone calls.

Other solutions that have been proposed include creating a new radio frequency (RF) system which would allow communication from the television viewer to the television signal provider through an RF link. This system, however, would require the creation of a new communications infrastructure covering vast geographic areas. Such a system may be prohibitively expensive to implement.

### SUMMARY OF THE INVENTION

According to the present invention, the foregoing and other objects and advantages are attained by a system for providing a communications path from a viewer of a television controlled by a remote control unit to an information provider located at a central site. The system includes circuitry to receive a command signal from the remote control unit and to translate the command signal into a message to be relayed to the information provider. The command signal could be, for example, a command to purchase an advertised product or pay-per-view television event. A pager transmitter is included to transmit the message from the television viewer to the information provider over a wireless link. Additionally, a pager receiver may be included to receive a second message from the information provider over a second wireless link and circuitry is provided to take the received message and display it on the television screen as confirmation that the purchase command was received and accepted by the information provider. This two-way communications capability may be incorporated into a set-top box such as a cable television controller or video cassette recorder, or into a television.

In an embodiment of the present invention, a method of communicating between a television viewer and an information provider located at a central site includes the steps of displaying a prompt on a television to the television viewer requesting a viewer selection, accepting the viewer selection from the television viewer via a remote control unit for the television, VCR or set-top box, transmitting a command signal corresponding to the viewer selection from the remote control unit to the set-top box, translating the command signal into a pager message, and transmitting the pager message by a pager transmitter to the information provider over a wireless link.

Still other objects and advantages of the present invention will become readily apparent to those skilled in the art from the following detailed description, wherein is shown and described only the preferred embodiment of the invention, simply by way of illustration of the best mode contemplated for carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

FIG. 1 is a block diagram showing a two-way interactive television system according to the present invention.

FIG. 2 is a block diagram showing an alternative embodiment of a television system according to the present invention.

FIG. 3 is a block diagram of the present invention.

FIG. 4 is a block diagram showing an embodiment of the present invention incorporated into a Digital Packet Data paging network.

FIG. 5 is a diagram showing the frequency spectrum available for paging.

FIG. 6 is a block diagram showing an embodiment of the present invention incorporated into a Personal Communications Service paging network.

FIG. 7 is a block diagram showing simulcast transmission to the present invention.

### DESCRIPTION OF THE PREFERRED EMBODIMENT

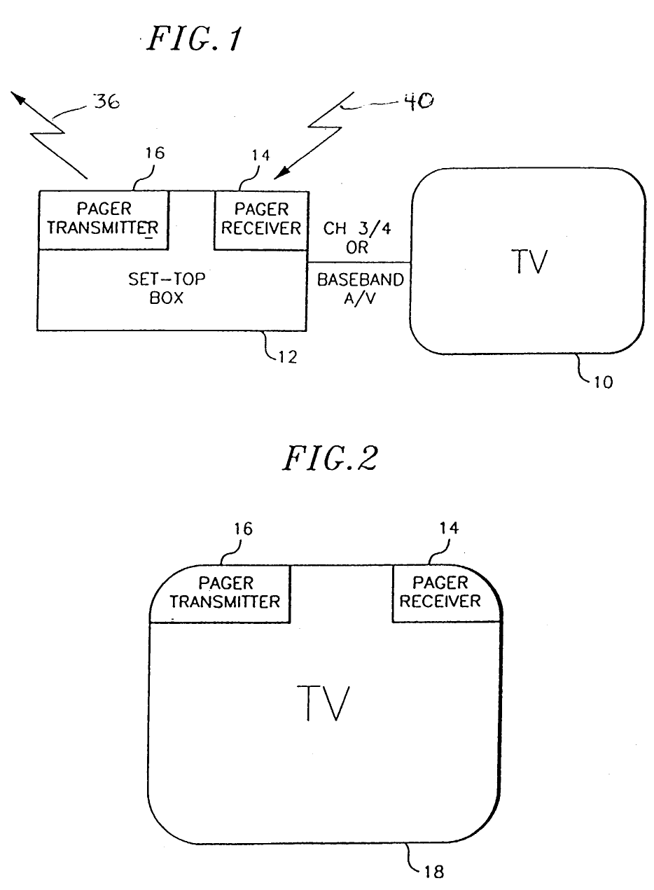

FIG. 1 is a block diagram showing a two-way interactive television system according to the present invention. In the preferred embodiment of the present invention, a television system includes a Television (TV) 10 connected to a Set-Top Box 12 via an RF connection using channels 3 or 4, a baseband video and audio connection, an S-video connection or any other conventional manner of communicating audio and video signals. In various embodiments, the Set-Top Box 12 could be a cable box, satellite receiver or any other type of consumer electronic device, such as a video cassette recorder (VCR) or a stand alone electronic program guide. The Set-Top Box 12 includes a Pager Transmitter 16 for sending information and may also include a Pager Receiver 14 for receiving information.

FIG. 2 is a block diagram showing an alternative embodiment of a television system according to the present invention. In this embodiment, the Pager Transmitter 16 and Pager Receiver 14 are contained in the Television 18.

The preferred embodiment of the present invention uses two-way paging services to provide communications from the television viewer to the television signal provider. Examples of network technologies that implement two-way paging are Motorola's ReFLEX protocol and AT&T's pACT protocol. ReFLEX is based on the Personal Communications Services (PCS) standard. The pACT technology is based upon a Cellular Digital Packet Data (CDPD) standard. These 2 way paging protocols allow initiation of a message from the subscriber's two-way Messaging device. Information transmitted may include, but is not limited to, the subscribers identity, an account to be billed, the service requested or order confirmation. These systems allows for the addition of a low cost pager transmitter into a television, set-top box or other consumer electronic device to provide communications from the television viewer back to the television signal provider. One advantage of these systems is that they do not require the establishment of a new communications infrastructure as would the other proposed RF systems.

In another embodiment of the invention only the paging transmitter is present in the set top box or the television set. A link is provided from the television viewer to the television signal provider or messaging service. This allows for the elimination of the paging receiver when information from the television signal provider or messaging service is not required by the television viewer.

Another advantage arising from the use of two-way paging services for communications from the television viewer to a television signal provider is that a low cost pager receiver could be added to the television, set-top box or other consumer electronic device to provide another communications path from the television signal provider to the television viewer.

A final advantage arising from the use of two-way paging services is that the simulcast paging signals have better in-building penetration than other means. Thus the paging signals have a greater probability of reaching television sets of the subscribers to the service.

In another alternative embodiment, a set-top box, television or other consumer electronic device can be equipped with both a pager transmitter and pager receiver of a two-way paging service system for communicating with an information provider other than a television signal provider. The type of information that could be communicated using this system would include any type of information that can be provided by modem to a personal computer, while using a television screen to display information and a native consumer electronic device (e.g., VCR, set-top box, television) remote control unit or universal remote control as an input device for the consumer.

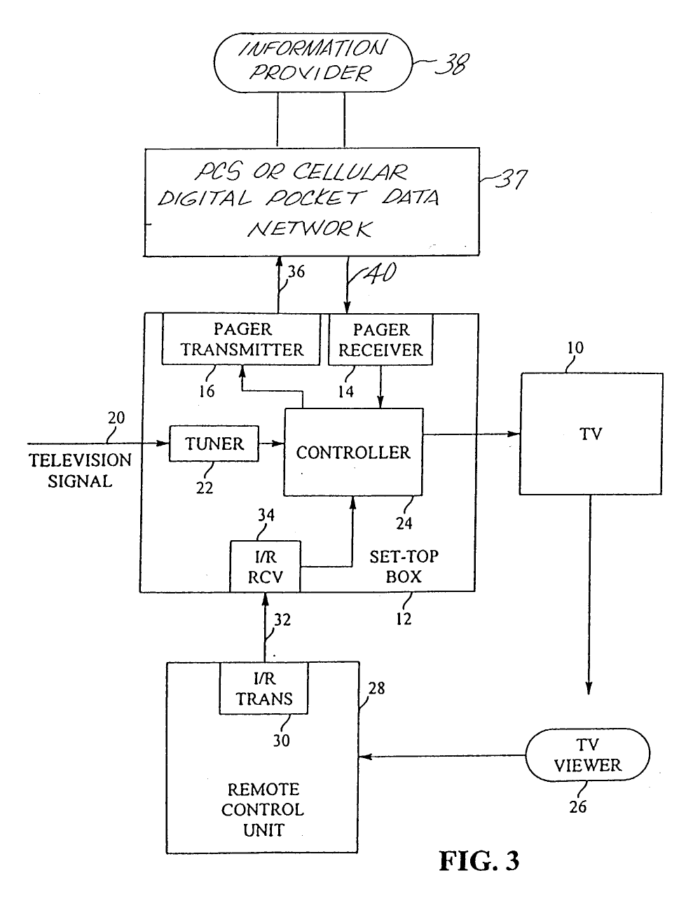

FIG. 3 is a block diagram of the present invention in either a PCS or CDPD system. A Television Signal 20 is input to the Set-Top Box 12 and processed by Tuner 22. The TV Signal can be received through an over-the-air antenna, by cable, by satellite reception or by any other conventional television communications medium. The tuned television program is sent by Controller 24 to the TV 10 for display to TV Viewer 26. In the preferred embodiment, the Controller 24 is a programmed microprocessor, although other control circuitry may be used. In a home shopping, pay-per-view, or other interactive television application, the television program shown on the TV prompts the TV Viewer 26 to make a selection or choice based on information presented on the TV screen. For example, the prompt may ask the TV Viewer 26 if he or she would like to purchase the right to view a pay-per-view event, purchase an advertised product, or respond to a survey question. To make a selection or send information back to the producer of the television program or other entity at a central site, the TV Viewer pushes an appropriate button (not shown) on the Remote Control Unit 28. The Remote Control Unit is a conventional remote control for a consumer electronics device such as a TV, VCR, and the like, having a plurality of buttons for user input. The Remote Control Unit senses the push of the button and sends a corresponding command signal via Infrared Transmitter (I/R TRANS) 30 over Infrared Link 32 to an Infrared Receiver (I/R RCV) 34 situated in the Set-Top Box 12. I/R RCV 34 forwards the command signal to the Controller 24 for processing. The Controller 24 directs Pager Transmitter 16 to send a message over Reverse Wireless Link through a wireless network, such as a PCS or Cellular Digital Packet Data Network. to an Information Provider 38. The message contains a unique viewer identifier, a data service identifier, and the viewer selection or response (e.g., a buy command). The data service identifier identifies the particular product being advertised or service being offered to the viewer. The Information Provider 38 may be a television station, broadcast or cable television network, advertiser, home shopping company, personal communications service network, or any other provider of information and services to the TV Viewer 26 via any communications medium.

Pager Transmitter 16 operates according to conventional two-way pager protocol of the given network in sending the message from the Set-Top Box 12 at the TV Viewer's location to the Information Provider 38 at a central site. Optionally, the Information Provider 38 sends a confirmation message in response to the TV Viewer's message over Forward Wireless Link 40 through Network Operations Center 37 to Pager Receiver 14. The confirmation message is forwarded to Controller 24 for display on TV 10, thereby providing immediate feedback to the TV Viewer that his or her selection was received and accepted.

Two-way paging, also known as acknowledgment paging, uses a set of radio channels allocated by the Federal Communications Commission (FCC) in the frequency spectrum at 900 MHZ. Two-way paging is also designated Narrowband Personal Communications Service (NPCS) or Personal Communication Service (PCS). It operates on a wider spectrum than one-way paging and is therefore capable of transmitting larger amounts of information. Two-way paging expands paging beyond simple message notification to a spectrum efficient system that allows the tracking of subscribers. Tracking subscribers allows for frequency reuse in the paging network. A response channel allows for confirmation messages to verify that the incoming message was received. Two-way paging uses an outbound communications channel for sending messages to the pager and an inbound communications channel for receiving pager responses. Examples of existing two-way paging services include SKYTEL TWO-WAY, available from SkyTel Corporation, and SKYPAGEII, available from Mobile Telecommunications Technologies Corporation. The pager hardware technology used by the SKYTEL2-WAY system is the TANGO pager available from Motorola, Inc. Examples of network protocols used in two-way paging services include the REFLEX family of network protocols from Motorola, Inc. and pACT technology available from ATT, Inc.

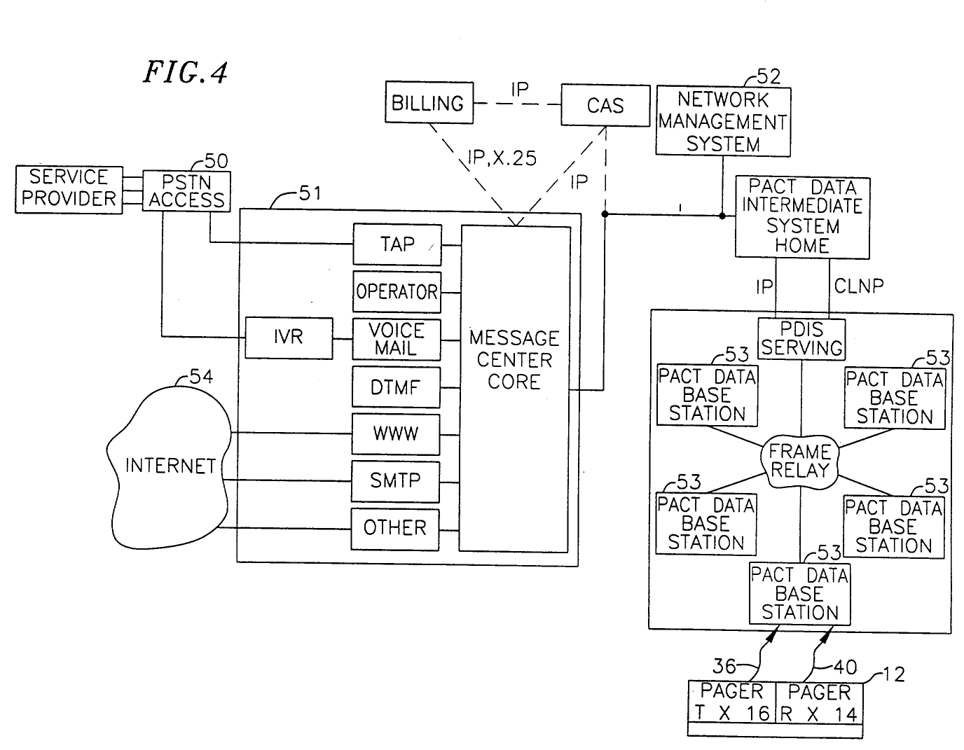

FIG. 4 shows the invention used in a pACT system. ATT's pACT Network Protocol is based on Cellular Digital Packet Data (CDPD). This standard is a means for providing Internet Protocol (IP) data service over cellular voice networks. The CDPD infrastructure uses existing cellular systems to access a backbone router that uses IP to transport data. The invention, personal digital assistants or computers that use IP can connect to the CDPD service and access message service providers, information providers or the television signal provider. CDPD offers data transmission rates from two to four times faster than many competing wireless data services. Most of these data services are limited to 9.6 Kbps or lower data rates. The pACT protocol is well suited for a number of applications. Examples are two-way paging, E-mail, telemetry, fleet management and dispatch, voice Messaging, Internet access and transaction processing. The pACT system is built from modules that can be combined and configured in different ways to meet specific operator requirements.

In FIG. 4 access from the public switched telephone network (PSTN) 50, or Internet 54 is provided by the message center 51. The message center initiates routes and connects pACT services to private and public networks including the Internet and the PSTN. The message center core handles almost any type of data and makes access possible for various interactive voice responses (IVR) and also voice or fax.

The network management system 52 provides every base station with parameters used to control traffic and maintain links to the network.

The pACT Database Stations (PDBS) are located at the cell site. They relay data between subscriber devices 12 via the base stations 53 and the serving pACT Data Intermediate System (PDIS).

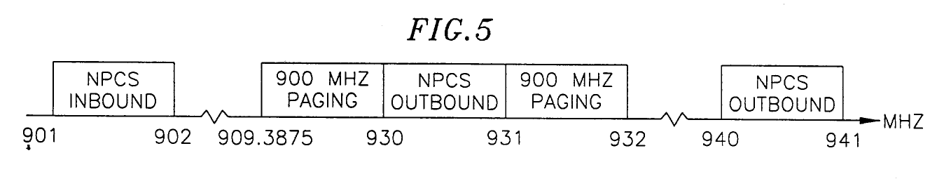

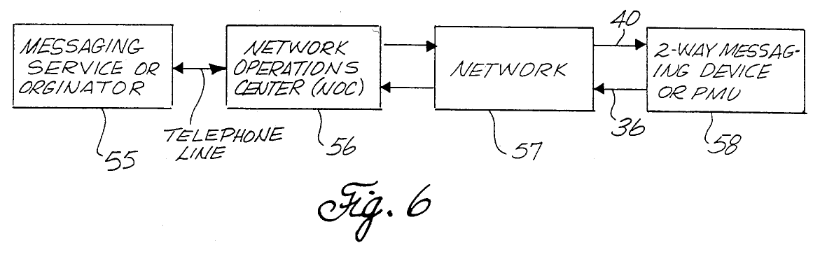

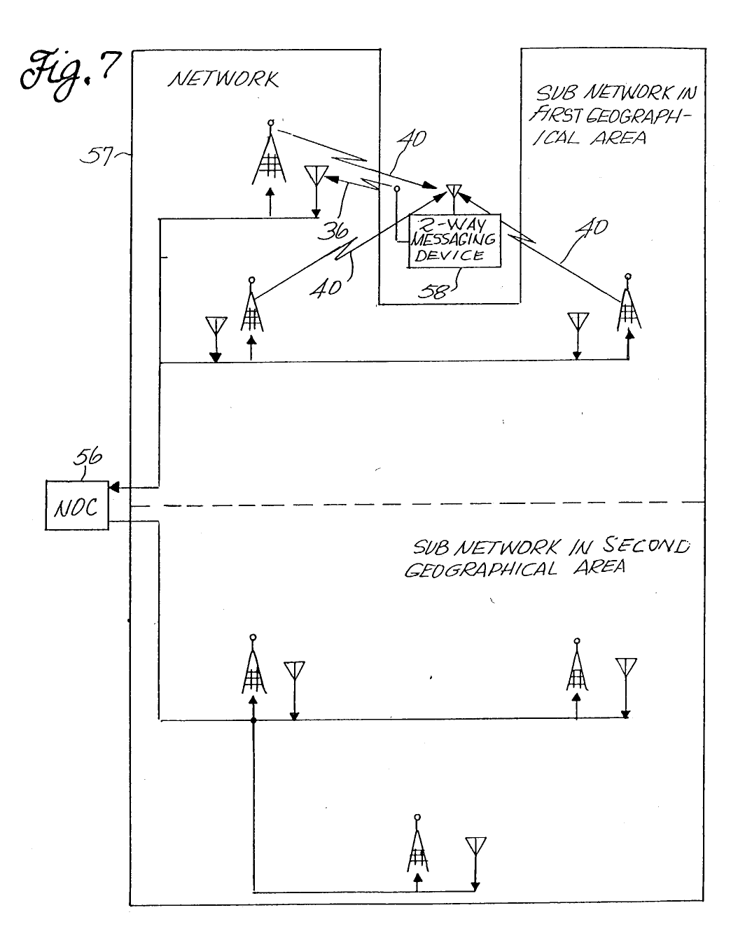

Another paging network that can be used with the present invention is the first generation Personal Communication Services (PCS) network, operating in the FCC allocated band of 901-940 MHz, shown in FIG. 5. The outbound portion of the 2 Mhz frequency spectrum is divided into two blocks. One block, at 940-941 Mhz, provides symmetrical 50/50 khz paired channels with the 1 Mhz inbound block at 901-902 Mhz (39 Mhz fixed duplex space). The other outbound block is located at 930-931 Mhz, where its asymmetrical licences reside (50/12.5 kHz). PCS is capable of sending and receiving at least hundreds of messages per minute. A current implementation of PCS is Motorola's ReFLEX Two-way Paging Protocol. ReFLEX technology not only allows subscribers to respond to pages it also allows subscribers to initiate messages to other subscribers, e-mail addresses or fax machines. The network, as shown in FIG. 6, consists of two separate paths, forward and reverse, that link a message service 55 or the message originator to a two-way Messaging device or personal Messaging unit (PMU) 58. The Network Operations Center (NOC) 56 and the Network 57 of Radio Frequency (RF) transmitters route the signals. In the preferred embodiment of FIG. 3, the forward channel is shown as Forward Wireless Link 40, and the reverse channel is shown as Reverse Wireless Link 36. The components of a PMU are shown as Pager Transmitter 16 and Pager Receiver 14 incorporated into Set-Top Box 12. Pager Transmitter 16 and Pager Receiver can also be integrated into a single component within the Set-Top Box 12.

An embodiment of a combined Pager Transmitter and Pager Receiver is the PAGEWRITER two-way Messaging unit commercially available from Motorola, Inc. The chip set for this device can be incorporated into the FIG. 3 pager transmitter 16 and pager receiver 14. The PAGEWRITER system can communicate with other pagers, fax machines, or Internet e-mail addresses. In this embodiment, Pager Receiver 14 operates in the 940-941 MHz frequency bands, with 50 KHz channel spacing, and at bit rates of 6400 bps. It supports signaling with 4 level frequency shift keying (FSK) at 3200 bps and 6400 bps, with a frequency deviation of +/−800 Hz and +/−2400 Hz for 4 level operation. In this embodiment, Pager Transmitter 16 operates in the 901-902 MHz frequency bands, with 12.5 KHz channel spacing, and at bit rates of 9600 bps. It supports signaling with 4 level FSK at 800, 1600, 6400, and 9600 bps, with a frequency deviation of +/−800 Hz and +/−2400 Hz for 4 level operation. The Tango, two way pager is another device from Motorola that operates in a similar manner to the PAGEWRITER. Chip sets from either of these devices could be used in the preferred embodiment shown in 12.

FIG. 7 shows the two way Messaging device 58 to network 57 link. The Forward Wireless Link 40 is a simulcast system using four subchannels. Simulcasting is a method of radio frequency (RF) transmission that in this case ensures maximum building penetration to ensure message delivery and receipt. In FIG. 7 signals from several antennas in the immediate area of the two-way Messaging device impinging on that device increase the probability of establishing a reliable signal link. The system tracks the location of the two-way Messaging device 58 and simulcasts only in that sub area. The reverse wireless link 36 is established with the network when the two-way Messaging unit transmits to a receiving antenna near the transmitting tower. This link establishes the location of the two-way Messaging device within the network 57, and provides a response channel.

The Reverse Wireless Link 36 connects Pager Transmitter 16 to a network of receivers (not shown). The receivers are connected to the NOC 56 via telephone lines and a frame-relay network. In a wide-area simulcast system, it is necessary to use multiple receivers scattered over a given area to ensure reverse channel coverage. Because the reverse channel Pager Transmitter 16 is directional, receivers must be spread so as to ensure there is a receiver available regardless of the position or location of the Pager Transmitter.

Each subchannel is modulated with four-level frequency-shift keying that operates at a speed of 6,400 bits per second. The channels can be used independently for high-capacity paging or combined for a throughput of 25,600 bits per second for delivering larger amounts of data to the Pager Receiver 14. This throughput is achieved by using well known multi-carrier modulation (MCM) technology combined with the REFLEX 50 paging protocol commercially available from Motorola, Inc.

FIG. 6 shows the link from the Network 53 to the Network Operations Center (NOC). Here the signals can be linked through satellite, line of site microwave or trunked telephone lines. The Messaging center 55 can be linked to the NOC 56 via a normal telephone line, as shown. With the present configuration, and using the four subchannels independently, the system capacity is in the range of 2 million to 3 million television viewers per NOC.

The invention has been described in its presently contemplated best mode, and it is clear that it is susceptible to various modifications, modes of operation and embodiments, all within the ability and skill of those skilled in the art and without the exercise of further inventive activity. Accordingly, what is intended to be protected by Letters Patent is set forth in the appended claims.

What is claimed is:

1. A consumer electronic device coupled to a television for providing a two-way wireless communication link from the television to a remote site comprising:
an interface for receiving a first message from the television and sending a second message to the television;
a transmitter coupled to the interface for transmitting the first message received from the television to the remote site over a wireless communication network; and
a receiver coupled to the interface for receiving the second message from the remote site over the wireless communication network, wherein the second message is sent to the television via the interface.

2. The consumer electronic device of claim 1 further comprising means for displaying the second message on a screen of the television.

3. The consumer electronic device of claim 1 further comprising a user input device for providing the first message to the television.

4. The consumer electronic device of claim 1, wherein the wireless communication network is a pager network.

5. The consumer electronic device of claim 4, wherein the paging network is a Personal Communication Services (PCS) network.

6. The consumer electronic device of claim 1, wherein the wireless communication network is a wireless telephone network.

7. The consumer electronic device of claim 1, wherein the second message is an advertisement.

8. The consumer electronic device of claim 1, wherein the second message is an electronic mail.

9. The consumer electronic device of claim 1, wherein the first message is an electronic mail.

10. A consumer electronic device plugged to a television for providing a two-way wireless communication link from the television to a remote site comprising:
an interface for receiving a first message from the television and sending a second message to the television;
a transmitter coupled to the interface for transmitting the first message received from the television to the remote site over a first wireless communication network; and
a receiver coupled to the interface for receiving the second message from the remote site over a second wireless communication network, wherein the second message is sent to the television via the interface.

11. The consumer electronic device of claim 10, wherein the first and second wireless communication networks are both pager networks.

12. The consumer electronic device of claim 10, wherein the first and second wireless communication networks are both wireless telephone networks.

13. The consumer electronic device of claim 10, wherein the first and second wireless communication networks are both pager networks.

14. The consumer electronic device of claim 10, wherein the first wireless communication network is a wireless pager network and the second wireless communication network is a simulcast system.

15. The consumer electronic device of claim 14, wherein the simulcast system includes four subchannels.

16. The consumer electronic device of claim 15, wherein each subchannel of the four subchannels is modulated with four-level frequency shift keying.

17. The consumer electronic device of claim 10, wherein the second message is an advertisement.

18. The consumer electronic device of claim 10, wherein the second message is an electronic mail.

19. The consumer electronic device of claim 10, wherein the first message is an electronic mail.

20. A portable two-way pager device plugged to a television for providing a two-way wireless communication link from the television to a remote site comprising:
an interface for receiving a first message from the television and sending a second message to the television;
a pager transmitter coupled to the interface for transmitting the first message received from the television to the remote site over a pager network;
a pager receiver coupled to the interface for receiving the second message from the remote site over the pager network, wherein the second message is sent to the television via the interface; and
a television screen for displaying the first message.
